(19) United States
(12) Patent Application Publication
(10) Pub. No.: US 2015/0234349 A1
(43) Pub. Date: Aug. 20, 2015

(54) TRANSFER SHEET FOR HOLOGRAM AND DESIGN FORMATION, MANUFACTURING PROCESS THEREFOR, AND MANUFACTURING PROCESS FOR HOLOGRAM-DESIGN-BEARING OBJECT

(71) Applicant: MATSUI SHIKISO CHEMICAL CO., LTD., KYOYO (JP)

(72) Inventors: Yosuke KITAGAWA, KYOTO (JP); Nobuyuki TONO, KYOTO (JP)

(21) Appl. No.: 14/624,627

(22) Filed: Feb. 18, 2015

(30) Foreign Application Priority Data
Feb. 19, 2014 (JP) 2014-29093

(51) Int. Cl. G03H 1/02; B32B 38/06; B32B 37/12; B32B 38/10; B32B 37/18; B32B 37/00

(52) U.S. Cl. CPC G03H 1/0256; B32B 37/18; B32B 37/025; B32B 37/12; B32B 38/10; B32B 38/06; B32B 2307/40; B32B 2451/00

(57) ABSTRACT

A hologram-forming layer is formed on all or a portion of a specified face of a sheet-like base material. A reversal-embossment-recording area with a reversal form of the desired hologram record by fine embossment is present on all or a portion on the side opposite to the base material of the hologram-forming layer. A portion including at least a portion of the reversal-embossment-recording area or all of said side where said hologram-forming layer has said reversal-embossment-recording area and a design-forming layer are stacked. Peelability exists between the hologram-forming layer and the design-forming layer, and a design having a hologram-recording area by fine embossment appears on the surface of the design-forming layer formed upon the peeling of the hologram-forming layer and the design-forming layer from each other.

### BACKGROUND OF THE INVENTION

1. Field of the Invention

The present invention relates to a transfer sheet for hologram and design formation to form a holographic design on a subject made of a clothlike fiber product, such as a clothing, or another subject, a manufacturing process therefor, and a manufacturing process for a hologram-design-bearing object to produce a object bearing a design with hologram using the transfer sheet for hologram and design formation.

2. Description of the Prior Art

Traditionally known means of generating a design on a clothlike fiber product (usually, a dye-colored or otherwise colored fiber product) that constitutes a clothing or the like are roughly divided into two techniques. First, the direct printing method is known to generate a design by printing a fiber product with a coloring ink having hiding performance on the fiber product, or to generate a design by forming a masking layer on the fiber product using a white ink having hiding performance, printing the masking layer with a coloring ink, and stacking the layer. Second, the thermal transfer method is known to include stacking a peeling layer, a design layer, and an adhesive layer on a base sheet made of heat-resistant paper or a synthetic resin film in this order to prepare a transfer sheet, thermally pressure-bonding the adhesive layer of the transfer sheet on the fiber product using a hot press machine or an iron to transfer and form a design, and thereafter peeling the base sheet.

The direct printing method is not efficient because a design must be formed by performing a printing work for each fiber product, and in addition it requires high skills for its operation.

In the case of the thermal transfer method, on the other hand, a transfer sheet can easily be prepared by sequentially printing a peeling layer, a design layer, and an adhesive layer on a base sheet with a resin ink using a printing machine, and it is also possible to obtain a large number of transfer sheets by forming a large number of peeling layers, design layers, and adhesive layers on a single base sheet at one time, and cutting off the base sheet. In addition, by thermally pressure-bonding an adhesive layer on the aforementioned fiber product using the transfer sheet with a hot press machine or an iron, it is possible to efficiently transfer and form a fine, brilliant, and stiff design (JP-A-HEI-5-287686).

In recent years, thermal transfer sheets having a hologram as a means to prevent a forgery from being made to the resulting design, or to confer a design property thereto, have been widespread. A hologram has an excellent decorative effect that allows stereoscopic images and special decoration images to be expressed by means of light interference, making it possible to increase added values such as design property and forgery prevention quality; in particular, techniques for use in credit cards, securities, and the like intended to prevent forgery have been proposed.

A technique described in JP-A-HEI-9-311616 is a technique pertaining to a transfer sheet having a base material, a peeling layer, a hologram-forming layer, a light-reflecting layer, and an adhesive layer, and intended to form a design on a hologram-forming layer made of a transparent material or metal prepared as a film, and is therefore incapable of forming a hologram on an optionally chosen multicolor design. In addition, its fastness is insufficient because the hologram-forming layer drops due to washing and the like.

A technique described in JP-A-2009-839 is a technique pertaining to a transfer sheet having a base material, an image-forming layer, a hologram layer, and a heat sealing layer, and, when transferred to a portion to be transferred, allowing the heat sealing layer to be formed on the article to be transferred, the hologram layer to be formed on the heat sealing layer, and an image to be formed on the hologram layer, wherein the image-forming layer has no hologram pattern per se because the hologram layer is formed under the image.

A technique described in JP-4985137 pertains to a transfer foil having a base material, a peelable protective layer, a hologram layer, a heat sealing layer, and an image-forming layer stacked sequentially, with a hologram formed on the image obtained when the transfer foil is transferred to a clothlike fiber product constituting a clothing or the like; however, because the hologram layer has been formed by transfer, the resulting hologram pattern cannot be retained due to the elasticity and flexibility of the fiber product such as a clothing or the like, and external strains such as washing and friction.

As stated above, techniques for forming a monochromic or polychromic design with a hologram remain unsatisfactory; therefore, there is a demand for the development of a transfer sheet that forms a design of excellent fastness with an added value such as forgery prevention or design property provision on a clothlike fiber product constituting a clothing or the like.

### SUMMARY OF THE INVENTION

A problem to be solved by one aspect of the present invention is to provide a transfer sheet for hologram and design formation to form a design with hologram on a subject made of a clothlike fiber product, such as a clothing, or another subject, in a state with excellent fastness, a manufacturing process therefor, and a manufacturing process for a hologram-design-bearing object to produce a hologram-design-bearing object using the transfer sheet for hologram and design formation.

The present inventors conducted extensive investigations to found that a transfer sheet for hologram and design formation which has a hologram-forming layer having a reversal-embossment-recording area with a reversed hologram record by fine embossment, and a design-forming layer, stacked on a base material, wherein a design by the design-forming layer having a hologram-recording area with a hologram recorded by the fine embossment, appears on a surface portion that has been formed upon the peeling of the hologram-forming layer and the design-forming layer from each other, and conducted further investigations to develop the present invention.

The transfer sheet for hologram and design formation, a manufacturing process therefor, and a manufacturing process for hologram-design-bearing object in one or more embodiments of the present invention can be described as follows:

(1) A transfer sheet for hologram and design formation having a sheet-like base material, a hologram-forming layer, and a design-forming layer, said hologram-forming layer is formed on all or a portion of a specified face of said base material,
said hologram-forming layer has a reversal-embossment-recording area with a desired hologram record by fine embossment in a reversed state on all or a portion of the side opposite to the base material,
a portion including at least a portion of the reversal-embossment-recording area or all of said side where said hologram-forming layer has said reversal-embossment-recording area and said design-forming layer are stacked, peelability exists between the hologram-forming layer and the design-forming layer, and
a design having a hologram-recording area by fine embossment appears on a surface portion of the design-forming layer which surface portion has been formed upon the peeling of the hologram-forming layer and the design-forming layer from each other.

By fixing the transfer sheet for hologram and design formation to a subject on the side opposite to the hologram-forming layer of the design-forming layer, and separating the base material and the hologram-forming layer from the design-forming layer to peel the hologram-forming layer from the design-forming layer, a design having a hologram-recording area by fine embossment on a surface portion of the design-forming layer which surface portion has been formed upon the peeling is obtained in a state fixed to the subject on the back side of the design-forming layer.

Because the design-forming layer from which the hologram-forming layer has been peeled has the hologram-recording area on a surface portion thereof, both a design and a reproduced holographic image by the design-forming layer appear brilliantly.

In addition, because the hologram-recording area in the design-forming layer is formed by stacking the design-forming layer on the fine embossment of the reversal-embossment-recording area in the hologram-forming layer, and appears on a surface portion of the design-forming layer which surface portion has been formed upon the peeling of the hologram-forming layer, the hologram-recording area in the design-forming layer, i.e., the hologram recorded by the fine embossment, is protected until the stacked hologram-forming layer and design-forming layer are peeled from each other. Therefore, the hologram-recording area with a hologram appearing on a surface portion of the design-forming layer upon the peeling of the hologram-forming layer, and recorded by the fine embossment, is prevented to the maximum possible extent from being damaged, even when the transfer sheet for hologram and design formation with the hologram-forming layer and the design-forming layer stacked therein is exposed to various forces and temperature changes, including pressurization in the direction of stacking and heating during fixation of the design-forming layer to a subject or other various handling procedures.

Furthermore, because the hologram-recording area is formed by stacking the design-forming layer on the reversal-embossment-recording area of the hologram-forming layer, and appears on a surface portion of the design-forming layer which surface portion has been formed upon the peeling of the hologram-forming layer, the hologram-recording area can be formed as a portion of the design-forming layer with a material capable of realizing desired fastness, design expression, and the like, without using a specially functional material in the hologram-recording area.

(2) The transfer sheet for hologram and design formation according to (1) above, having a masking layer on the side opposite to the hologram-forming layer of the design-forming layer.

By providing a masking layer on the side opposite to the hologram-forming layer of the design-forming layer, design brilliancy by the design-forming layer and hologram pattern visibility can be improved.

(3) The transfer sheet for hologram and design formation according to (1) above, having an adhesive layer on the side opposite to the hologram-forming layer of the design-forming layer.

By joining the transfer sheet for hologram and design formation to a subject by means of an adhesive layer that is present on the side opposite to the hologram-forming layer of the design-forming layer (via another layer and the like as required), and peeling the hologram-forming layer from the design-forming layer, a design having the hologram-recording area by fine embossment on a surface portion of the design-forming layer which the surface portion has been formed upon the peeling is obtained in a state fixed to the subject in the adhesive layer located on the back side of the design-forming layer.

(4) The transfer sheet for hologram and design formation according to (3) above, having a masking layer between the design-forming layer and the adhesive layer.

By providing a masking layer between the design-forming layer and the adhesive layer, design brilliancy by the design-forming layer and hologram pattern visibility can be improved.

(5) The transfer sheet for hologram and design formation according to (3) or (4) above, wherein said base material is in the form of a heat-resistant sheet,
said adhesive layer, in contact with the subject, is heated and pressurized from the side opposite to the hologram-forming layer of the sheet-like base material to allow the adhesive layer to be fusion bonded to said subject, and to be fixed to the subject upon cooling.

By heating and pressurizing the transfer sheet for hologram and design formation to the subject from the side opposite to the hologram-forming layer of the sheet-like base material, while the adhesive layer of the transfer sheet is in contact with the subject, to fusion bond the adhesive layer to the subject, and then solidifying the adhesive layer by spontaneous cooling or another means of cooling, the adhesive layer can be fixed to subject.

Subsequently, by separating the base material and the hologram-forming layer from the design-forming layer to peel the hologram-forming layer from the design-forming layer, a design having a hologram-recording area by fine embossment on a surface portion of the design-forming layer which surface portion has been formed upon the peeling is obtained in a state fixed to the subject in the adhesive layer located on the back side of the design-forming layer.

(6) The transfer sheet for hologram and design formation according to any one of (1) to (5) above, wherein the base material and the hologram-forming layer can be integrally peeled from the design-forming layer.

It is preferable that the base material and the hologram-forming layer be integrally peelable from the design-forming layer.

(7) The transfer sheet for hologram and design formation according to any one of (1) to (6) above, wherein said transfer sheet as a whole is in the form of a flexible sheet.

(8) A manufacturing process for a transfer sheet for hologram and design formation including
a step for forming a hologram-forming layer on all or a portion of a specified face of a sheet-like base material, said hologram-forming layer having a reversal-embossment-recording area with a desired hologram record by fine embossment in a reversed state in all or a portion of the side opposite to the base material, and
a step for stacking a design-forming layer on a portion including at least a portion of said reversal-embossment-recording area or all of said side where said hologram-forming layer has said reversal-embossment-recording area, wherein
peelability exists between the hologram-forming layer and the design-forming layer, and
a design having a hologram-recording area by fine embossment appears on a surface portion of the design-forming layer which surface portion has been formed upon the peeling of the hologram-forming layer and the design-forming layer from each other.

This manufacturing process makes it possible to produce the transfer sheet for hologram and design formation of the present invention.

(9) The manufacturing process for a transfer sheet for hologram and design formation, according to (8) above, having a step for providing an adhesive layer on the side opposite to the hologram-forming layer of said design-forming layer.

A transfer sheet for hologram and design formation having an adhesive layer on the side opposite to the hologram-forming layer of the design-forming layer (via another layer or the like as required) can be produced.

(10) The manufacturing process for a transfer sheet for hologram and design formation according to (9) above, wherein said base material is in the form of a heat-resistant sheet,
said adhesive layer, in contact with the subject, is heated and pressurized from the side opposite to the hologram-forming layer of the sheet-like base material to allow the adhesive layer to be fusion bonded to the subject, and to be fixed to the subject by cooling.

(11) The manufacturing process for a transfer sheet for hologram and design formation according to any one of (8) to (10) above, wherein the base material and the hologram-forming layer can be integrally peeled from the design-forming layer.

(12) A manufacturing process for a hologram-design-bearing object including
a step for fixing the transfer sheet for hologram and design formation according to (1) or (2) above to an article on the side opposite to the base material, and
a step for separating the base material and the hologram-forming layer from the design-forming layer to peel the hologram-forming layer from the design-forming layer, thus yielding an object with the design-forming layer from which the hologram-forming layer has separated,
wherein a design having a hologram-recording area by fine embossment appears, upon the peeling, on a surface portion of the design-forming layer which surface portion has been formed upon the peeling.

By fixing the transfer sheet for hologram and design formation according to (1) or (2) above to an article (subject) on the side opposite to the hologram-forming layer of the design-forming layer, and separating the base material and the hologram-forming layer from the design-forming layer to peel the hologram-forming layer from the design-forming layer, a hologram-design-bearing object, in a state fixed to the article on the back side of the design-forming layer (a masking layer or the like may be interposed between the back face of the design-forming layer and the article), is obtained. The surface portion of the design-forming layer, which surface portion has been formed upon the peeling, has a hologram-recording area by fine embossment.

Because the design-forming layer from which the hologram-forming layer has been peeled has the hologram-recording area on a surface portion thereof, both the design and a reproduced holographic image by the design-forming layer appear brilliantly.

In addition, because the hologram-recording area in the design-forming layer is formed by stacking the design-forming layer on the fine embossment of the reversal-embossment-recording area in the hologram-forming layer, and appears on a surface portion of the design-forming layer which surface portion has been formed upon the peeling of the hologram-forming layer, the hologram-recording area in the design-forming layer, i.e., the hologram recorded by the fine embossment, is protected until the stacked hologram-forming layer and design-forming layer are peeled from each other.

Furthermore, because the hologram-recording area is formed by stacking the design-forming layer on the reversal-embossment-recording area of the hologram-forming layer, and appears on a surface portion of the design-forming layer which surface portion has been formed upon the peeling of the hologram-forming layer, the hologram-recording area can be formed as a portion of the design-forming layer with a material capable of realizing desired fastness, design expression, or the like, without using a specially functional material in the hologram-recording area.

(13) A manufacturing process for a hologram-design-bearing object including
a step for heating and pressurizing the transfer sheet for hologram and design formation according to (5) above from the side opposite to the hologram-forming layer of the sheet-like base material, while the adhesive layer is in contact with an article, to fusion bond the adhesive layer to said article,
a step for solidifying the fusion bonded adhesive layer by cooling to fix the fusion bonded adhesive layer to the article, and
a step for separating said base material and the hologram-forming layer from said design-forming layer to peel the hologram-forming layer from the design-forming layer, thus yielding an object with the design-forming layer from which the hologram-forming layer has separated,
wherein a design having a hologram-recording area by fine embossment appears, upon the peeling, on a surface portion of the design-forming layer which surface portion has been formed upon the peeling.

By fixing the transfer sheet for hologram and design formation according to (5) above to an article (subject) with the adhesive layer, and peeling the hologram-forming layer from the design-forming layer, a hologram-design-bearing object is obtained while a design having a hologram-recording area by fine embossment on a surface portion of the design-forming layer which surface portion has been formed upon the peeling is fixed with the adhesive layer (a masking layer or the like may be interposed between the design-forming layer and the article).

Because the design-forming layer from which the hologram-forming layer has been peeled has a hologram-recording area on a surface portion thereof, both the design and a reproduced holographic image by the design-forming layer appear brilliantly.

In addition, because the hologram-recording area in the design-forming layer is formed by stacking the design-forming layer on the fine embossment of the reversal-embossment-recording area in the hologram-forming layer, and appears on a surface portion of the design-forming layer which surface portion has been formed upon the peeling of the hologram-forming layer, the hologram-recording area in the design-forming layer, i.e., the hologram recorded by the fine embossment, is protected until the stacked hologram-forming layer and design-forming layer are peeled from each other.

Furthermore, because the hologram-recording area is formed by stacking the design-forming layer on the reversal-embossment-recording area of the hologram-forming layer, and appears on a surface portion of the design-forming layer which surface portion has been formed upon the peeling of the hologram-forming layer, the hologram-recording area can be formed as a portion of the design-forming layer with a material capable of realizing desired fastness, design expression, or the like, without using a specially functional material in the hologram-recording area.

According to the transfer sheet for hologram and design formation in one aspect of the present invention, by peeling the stacked hologram-forming layer and design-forming layer, a design having a hologram-recording area by fine embossment on a surface portion of the design-forming layer which surface portion has been formed upon the peeling is obtained. Because the design-forming layer from which the hologram-forming layer has been peeled has the hologram-recording area on a surface portion thereof, both the design and a reproduced holographic image by the design-forming layer appear brilliantly.

In addition, because the hologram-recording area in the design-forming layer is formed by stacking the design-forming layer on the fine embossment of the reversal-embossment-recording area in the hologram-forming layer, and appears on a surface portion of the design-forming layer which surface portion has been formed upon the peeling of the hologram-forming layer, the hologram-recording area in the design-forming layer, i.e., the hologram recorded by the fine embossment, is protected until the stacked hologram-forming layer and design-forming layer are peeled from each other.

Furthermore, because the hologram-recording area is formed by stacking the design-forming layer on the reversal-embossment-recording area of the hologram-forming layer, and appears on a surface portion of the design-forming layer which surface portion has been formed upon the peeling of the hologram-forming layer, the hologram-recording area can be formed with a material capable of realizing desired fastness, design expression, and the like as a portion of the design-forming layer, without using a specially functional material in the hologram-recording area.

The manufacturing process for a transfer sheet for hologram and design formation of the present invention makes it possible to produce the transfer sheet for hologram and design formation of the present invention.

According to the manufacturing process for a hologram-design-bearing object of the present invention, a hologram-design-bearing object with a design-forming layer having a hologram-recording area on a surface portion thereof can be produced using the transfer sheet for hologram and design formation of the present invention.

### DETAILED DESCRIPTION OF THE INVENTION

Modes for embodying the present invention are described below.

1. Transfer Sheet for Hologram and Design Formation

(1) The transfer sheet for hologram and design formation of the present invention has a sheet-like base material, a hologram-forming layer, and a design-forming layer.

The transfer sheet for hologram and design formation of the present invention may, for example, be one having a sheet-like base material, a hologram-forming layer, and a design-forming layer in this order, one having a sheet-like base material, a hologram-forming layer, a design-forming layer, and a masking layer in this order, one having a sheet-like base material, a hologram-forming layer, a design-forming layer, and an adhesive layer in this order, or one having a sheet-like base material, a hologram-forming layer, a design-forming layer, a masking layer, and an adhesive layer in this order.

In addition, the transfer sheet for hologram and design formation of the present invention may be one having an adhesive layer on the side opposite to the hologram-forming layer of the design-forming layer (via another layer as required).

Furthermore, the transfer sheet for hologram and design formation of the present invention may be one having an auxiliary layer, a functionalizing layer, or the like, such as a dye-adsorption layer and a protective layer, in a state, for example, adjacent or appendant to any layer.

Although it is preferable that the transfer sheet for hologram and design formation of the present invention is in the form of a flexible sheet as a whole, this is not to be construed as limiting. In addition, the transfer sheet for hologram and design formation of the present invention may be one for transferring a design by the design-forming layer to a subject by thermal transfer or the like; however, this is not to be construed as limiting.

(2) Base Material

The base material is in the form of a sheet, and is intended to form the hologram-forming layer on all or a portion (one or a plurality of portions) of a specified face thereof.

The sheet-like base material may be in the form of a sheet such as a rectangular sheet, of specified dimensions, and may also be in the form of a continuous sheet, for example, a cylindrically rolled one (rolled sheet).

It is desirable that the sheet-like base material be one wherein a specified face that constitutes all thereof or at least the hologram-forming layer thereof possesses a surface smoothness suitable for the formation of the hologram-forming layer.

Although it is preferable that the thickness of the sheet-like base material (base sheet) be, for example, approximately 50 to 200 micro m, this is not limiting.

The sheet-like base material, when the transfer sheet for hologram and design formation is one such that a design by the design-forming layer is formed on a subject by thermal transfer or the like, may be one possessing a heat resistance, pressure resistance, and the like that allow the material to endure conditions of the thermal transfer and the like (e.g., transfer temperature: 100 to 200 degrees Celsius, transfer time: 2 to 30 seconds, transfer pressure: 10 to 500 kPa).

Useful sheet-like base materials include, for example, paper or synthetic resin films as base sheets, with preference given to polyester films and polyimide films from the viewpoint of heat resistance and surface smoothness; for transfer at relatively low temperature, polyolefin films such as polypropylene films can be used.

(3) Hologram-Forming Layer

The hologram-forming layer has a reversal-embossment-recording area on all or a portion of one side thereof. When the hologram-forming layer is formed on all or a portion of a specified face of the sheet-like base material, the reversal-embossment-recording area is present in all or a portion thereof on the side opposite to the base material of the hologram-forming layer.

The reversal-embossment-recording area is a reversal record of a desired hologram record by fine embossment, i.e. fine relief structure, (fine embossment, i.e. fine relief structure, allowing a desired reproduced image to be obtained).

The hologram-forming layer having the reversal-embossment-recording area can be formed with, for example, an ultraviolet curing resin ink or the like including a functional monomer or oligomer such as of an acrylate, methacrylate, urethane acrylate, or epoxy acrylate, and a sensitizer and the like.

The hologram-forming layer having the reversal-embossment-recording area can be formed by, for example, coating an ultraviolet curing resin ink as described above (or another material) to all or a portion of a specified face (e.g., one face) of a sheet-like base material to provide an ink film on the specified face, pressing an embossing die of a holographic molding over all or a portion of the surface of the ink film (or by another means) to provide reversed embossment in a reversal form of the desired hologram record by fine embossment, and, in this state, applying an ultraviolet ray to the ink film to cure the ink film and make the reversed embossment a cured reversal-embossment-recording area.

Peelability need to exist between the hologram-forming layer and the design-forming layer stacked on the reversal-embossment-recording area side of the hologram-forming layer (or the design-forming layer with a protective layer as an auxiliary layer on the hologram-forming layer side). To adjust this peelability, the ultraviolet curing resin ink for forming the hologram-forming layer (or another material for forming the hologram-forming layer) may be blended with, for example, silicone, a fluorine compound, a wax, or the like.

It is preferable that the base material and the hologram-forming layer can easily be peeled integrally from the design-forming layer (or the design-forming layer with a protective layer as an auxiliary layer on the hologram-forming layer side) by possessing mutual bondability (e.g., an adhesive layer [primer layer] is provided between the two members to make them bondable to each other) or the like.

(4) Design-Forming Layer, Adhesive Layer, Masking Layer, and Dye-Adsorption Layer

Each of the design-forming layer, the adhesive layer, the masking layer, and the dye-adsorption layer can be formed with a material that includes a resin as the principal ingredient, is colored with a coloring agent as required, and contains other necessary ingredients as required.

Examples of resins that can be used as principal ingredients of the various layers include synthetic resins such as polyurethane resin, polyacrylate resin, polyvinyl chloride resin, vinyl chloride/vinyl acetate copolymer resin, ethylene/vinyl acetate copolymer resin, styrene-butadiene copolymer resin, polyester resin, and nylon (polyamide) resin. The design-forming layer may be provided with a protective layer as an auxiliary layer on the hologram-forming layer side thereof, and the protective layer may incorporate such a resin as the principal ingredient.

The aforementioned resins can be chosen from the viewpoint of fastness requirements, including washing fastness, friction fastness, and light fastness, and the like in a practical use in which, for example, at least the design-forming layer or a lamination of the design-forming layer and the aforementioned various layers is fixed on a textile product such as a clothing or another flexible subject or another subject, and resins that can be used preferably from this viewpoint include aliphatic urethane resins.

The use of an aliphatic urethane resin as the principal ingredient of the design-forming layer is also preferable in that peelability from the hologram-forming layer (particularly the hologram-forming layer with the aforementioned ultraviolet curing resin ink cured by an ultraviolet ray).

In addition, to make the principal ingredient resin suitable for fixation of the design-forming layer and the like to an stretchable or flexible subject, it is preferable that the 100% modulus of the resin used as the principal ingredient of each layer be in the range of 0.5 to 50 MPa.

When the transfer sheet for hologram and design formation is, for example, one wherein a heat-resistant sheet-like base material, a hologram-forming layer, a design-forming layer, a masking layer, and an adhesive layer are present in this order, and wherein by heating and pressurizing the adhesive layer, in contact with a subject, from the side opposite to the hologram-forming layer of the sheet-like base material, to fusion bond the adhesive layer to the subject, solidifying the adhesive layer by spontaneous cooling or another means of cooling to fix the adhesive layer to the subject, and then separating the base material and the hologram-forming layer from the design-forming layer to peel the hologram-forming layer from the design-forming layer, thus yielding a design having a hologram-recording area by fine embossment on a surface portion of the design-forming layer which surface portion has been formed upon the peeling, in a state fixed to the subject in the adhesive layer located on the back side of the design-forming layer via the masking layer, and in other cases involving layer heating, such as a case wherein the design-forming layer and the like are thermally transferred to the subject, it is desirable for securing stability of each layer during heating such as in thermal transfer that the softening point of the aliphatic urethane or other resin serving as the principal ingredient of each layer be 100 to 200 degrees Celsius.

As a hot melting resin that can be used to confer hot melt bondability to the adhesive layer (a resin that fuses upon heating, and bonds upon cooling solidification), it is preferable to use a powdered resin such as of polyurethane resin, polyester resin, or nylon resin, which may be used in mixture.

To form each layer using such a resin, it is preferable that the resin be used after being prepared as a resin ink by dissolving and/or dispersing the resin in an organic solvent, or by dispersing the resin in water, or by emulsifying the resin. Examples of other ingredients of such inks include necessary coloring agents, curing agents, thickeners, defoaming agents, plasticizers, extender pigments, antioxidants, other additives, and the like. By performing printing using a printing machine or coating with such a resin ink, each layer can be formed. Formation of each layer using a resin is also possible by, for example, thermally melting the resin, and extruding it using a T-die, or the like.

The design-forming layer can be formed by, for example, a gravure printing process, an offset printing or screen printing process, knife coating, comma coating, or the like.

Since the masking layer, adhesive layer, and dye-adsorption layer need to have a thickness sufficient to allow them to exhibit their function, it is preferable that these layers be formed using screening printing, knife coating, comma coating, a T-die, or the like.

The adhesive layer can be formed by, for example, using a resin ink with hot melt bondability or an ink prepared by dispersing hot melting resin particles (those having a particle diameter of, for example, approximately 20 to 80 micro m) in a resin ink, and can also be prepared by spreading hot melting resin particles (those having a particle diameter of, for example, approximately 80 to 300 micro m) on a layer formed using a resin ink, or by thermally melting these resins and extruding it using a T-die or the like. Such hot melting resin particles can be prepared by, for example, forming into a particulate form by polymerization, or by milling.

(4-1) Design-Forming Layer

The design-forming layer is intended to form a design and a hologram-recording area, and formed by stacking a portion including at least a portion of the reversal-embossment-recording area or all of the side where said hologram-forming layer has said reversal-embossment-recording area and the design-forming layer. The hologram-recording area in the design-forming layer with a hologram recorded by fine embossment is formed by stacking the design-forming layer on the fine embossment of the reversal-embossment-recording area in the hologram-forming layer, and appears on a surface portion of the design-forming layer which surface portion is formed upon the peeling of the reversal-embossment-recording area of the hologram-forming layer and the design-forming layer from each other. The design-forming layer may be one with a protective layer as an auxiliary layer on the side of the hologram-forming layer.

Specifically, the design-forming layer can be formed by, for example, printing or coating a resin ink in a desired shape on all or a portion including at least reversal-embossment-recording area on the side of the hologram-forming layer, which has been formed on a specified face of the sheet-like base material (e.g., one face of the base material), having the reversal-embossment-recording area. When a protective layer is provided, first, a resin ink is likewise printed or coated to form a protective layer, and the resin ink is further printed or coated to form a design-forming layer. The thickness of the design-forming layer can be, for example, approximately 2 to 50 micro m, and the thickness of the protective layer if any can be, for example, approximately 2 to 20 micro m; however, this is not to be construed as limiting.

By separating the base material and the hologram-forming layer from the design-forming layer to peel the stacked hologram-forming layer and the design-forming layer from each other, a design having a hologram-recording area by fine embossment appears on a surface portion of the design-forming layer which surface portion has been formed upon the peeling. When the transfer sheet for hologram and design formation is joined to the subject on the side opposite to the base material (i.e., the side opposite to the hologram-forming layer of the design-forming layer), a design having a hologram-recording area by fine embossment is obtained on a surface portion of the design-forming layer which surface portion has been formed upon the peeling in a state fixed to the subject on the back side of the design-forming layer.

The design formed by the design-forming layer can be, for example, a drawing, a character, a figure, or a symbol, or a combination of two or more thereof, can also be a monochromic, dichromic, or polychromic design, and can still also be a design such as a drawing, a character, a figure, or a symbol by, for example, cutting the design-forming layer that has been formed over the entire surface using a cutting machine or the like to remove unwanted portions.

The resin ink or the like used to form the design-forming layer by printing or the like is usually one that has been colored with various coloring agents such as organic pigments or inorganic pigments and the like; however, this is not to be construed as limiting.

Examples of coloring agents that can be used in the design-forming layer include, but are not limited to, black pigments such as carbon black and black iron oxide pigment; yellow pigments such as azo pigments, imidazolone pigments, and titanium yellow pigments; red pigments such as azo pigments, quinacridone pigments, chromophtal pigments, diketopyrrolopyrrole pigments, and anthraquinone pigments; blue pigments such as phthalocyanine pigments; white pigments such as titanium oxide, aluminum silicate, and silicon oxide; orange pigments such as indanthrene pigments; purple pigments such as dioxadine pigments; and green pigments such as phthalocyanine pigments. Useful coloring agents also include metal powders such as aluminum powders, aluminum pastes, pearl pigments, brass powders, glitters, and the like, as well as special coloring matters such as thermochromic pigments, photochromic pigments, and light-accumulating pigments. Coloring agents can be used not only singly, but also in combination of two kinds or more.

As stated above, peelability need to be present between the hologram-forming layer and the design-forming layer stacked on the reversal-embossment-recording area side of the hologram-forming layer (or the design-forming layer with a protective layer as an auxiliary layer on the hologram-forming layer side). To adjust this peelability, the resin ink for forming the hologram-forming layer or the like (or a resin or the like for forming the hologram-forming layer) may be blended with, for example, silicone, a fluorine compound, a wax, and the like.

The protective layer is an auxiliary layer formed on the hologram-forming layer side of the design-forming layer as required for the purpose of protecting the design by retaining the surface strength of the design by the design-forming layer having a hologram-recording area on a surface portion that has been formed upon the peeling of the hologram-forming layer or by another means, and is not essential. Although the protective layer is usually colorless transparent, this is not to be construed as limiting.

A portion lacking the hologram-forming layer may be present between the base material and the design-forming layer, and peelability need to be present between the base material and the design-forming layer in the portion. Such peelability can be adjusted by blending, for example, silicone, a fluorine compound, a wax, and the like in a resin ink or the like for forming the design-forming layer (when a protective layer is formed, a resin ink or the like for forming the protective layer) or by another means.

(4-2) Adhesive Layer

The adhesive layer is intended to fix at least the design-forming layer having a hologram-recording area in a surface portion thereof (or the design-forming layer with a protective layer) to a subject on the back side thereof. In the case of one having a masking layer, a dye-adsorption layer, and the like on the back side of the design-forming layer, such layers stacked on the back side of the design-forming layer having a hologram-recording area on a surface portion thereof may be fixed integrally to the subject by means of an adhesive layer.

Although it is desirable that the adhesive layer be capable of being fusion bonded to the subject under heating and pressurization and solidified by spontaneous cooling or another means of cooling to fix itself to the subject, this is not to be construed as limiting. Examples of adhesive layers that can be fusion bonded under heating and pressurization, and solidified by cooling to fix them to the subject include those comprising a resin with hot melt bondability as the principal ingredient. The heating temperature may be a temperature at which the adhesive layer melts, whereas no other layer of the transfer sheet for hologram and design formation other than the adhesive layer undergoes melting, damage, and the like. Other examples include one that can be fixed to the subject by pressurizing at normal temperature by using a tacky resin in the adhesive layer, and one that can be fixed to the subject at normal temperature using another adhesive in the adhesive layer.

The adhesive layer can be formed on the side opposite to the hologram-forming layer of the design-forming layer (via a masking layer, a dye-adsorption layer, and the like as required).

The adhesive layer that can be fusion bonded under heating and pressurization, and solidified by cooling to fix itself to the subject can be formed as stated above by, for example:

a) using a resin ink with hot melt bondability,

b) using an ink prepared by dispersing hot melting resin particles in a resin ink,

c) spreading hot melting resin particles on a layer formed with a resin ink, heating the hot melting resin particles to slightly melt them, and allowing the hot melting resin particles to be carried by the resin ink layer, and

d) heating and melting hot melting resin particles, and extruding the particles using a T-die or the like.

In the case of c) and d), the adhesion force of the adhesive layer against a subject to be transferred is stronger because hot melting resin particles or a molten solidified product thereof is situated on a surface portion of the adhesive layer on the side compressively fusion bonded to the subject.

The thickness of the adhesive layer can be, for example, approximately 30 to 200 micro m; however, this is not to be construed as limiting.

It is preferable for preventing misregistration that the adhesive layer be formed in a way such that the peripheral portion thereof protrudes from the peripheral portion of the design-forming layer (including a portion of the layer that constitutes the masking layer, when it constitutes a portion of the design-forming layer as described below). The width of the protrusion of the peripheral portion of the adhesive layer from the peripheral portion of the design-forming layer can be substantially constant in the range of, for example, 0.1 to 1.0 mm; however, this is not to be construed as limiting. The peripheral portion, when both an outer periphery and an inner periphery are present in the design, like in an annular figure, the peripheral portion includes both the outer peripheral portion and the inner peripheral portion.

(4-3) Masking Layer

The masking layer can be provided to prevent the appearance, view, or the like of the design by the design-forming layer from being influenced by the color, pattern, darkness/lightness, and other properties of the relevant portion of the subject or the like to which it is fixed on the back side of the design-forming layer or the like, or to confer effects such as making the design stand out, or for other purposes.

The masking layer can be formed on the side opposite to the hologram-forming layer of the design-forming layer, and when an adhesive layer is present, between the design-forming layer and the adhesive layer. The masking layer is usually stacked directly on the side opposite to the hologram-forming layer of the design-forming layer.

The masking layer can usually be prepared as a white layer that does not transmit visible light. Such a masking layer can be formed with, for example, a material blended with a white pigment or the like. For example, a masking layer can be formed by printing an ink prepared by blending titanium oxide, silicon oxide, aluminum silicate, or the like as a hiding agent (white pigment) in a resin ink including a resin as described above as the principal ingredient to impart a white color. However, this is not to be construed as limiting; for example, the masking layer can also be formed by containing a non-white coloring agent, e.g., aluminum, a pearl pigment, or the like, in a resin ink.

The thickness of the masking layer can be, for example, approximately 10 to 80 micro m; however, this is not to be construed as limiting.

The necessity for a masking layer is usually high when the subject portion to be transferred is relatively densely colored; by using a masking layer, design brilliancy by the design-forming layer and hologram pattern visibility can be improved.

When, for example, the color, pattern, or the like of the design to be expressed appear, in all or a portion of the design, not exclusively by the design-forming layer, but by their overlap with the color, pattern, or the like of the relevant portion of the subject or the like to which it is fixed, on the back side of the design-forming layer or the like, no masking layer is used in all or the portion.

In addition, the layer that constitutes the masking layer may have a portion that overlaps with the design-forming layer (portion that functions as the masking layer) and a portion that appears as a portion of a design that does not overlap with the portion (portion that functions as a portion of the design-forming layer). When, for example, a masking layer and a design-forming layer are formed respectively (particularly by printing), the peripheral portion of the design-forming layer may protrude slightly from the peripheral portion of the masking layer, or the peripheral portion of the layer that constitutes the masking layer may protrude from the peripheral portion of the design-forming layer to allow the protruded portion to serve as a portion of the design (to constitute a portion of the design-forming layer), since the outlines of the two layers do not always agree accurately with each other. Otherwise, a portion of the layer that constitutes the masking layer may be a portion of the design except in the protruded portion.

(4-4) Dye-Adsorption Layer

The dye-adsorption layer can be formed in order to prevent the design-forming layer or the masking layer from being contaminated to the extent that hampers the manifestation of the desired design due to sublimation of a sublimable dye used in the subject or the like, caused by the heat applied to the adhesive layer for joining the design-forming layer and the like onto the subject by thermal fusion.

The dye-adsorption layer is desirably provided when the portion of the subject to which the design-forming layer or the like is joined has been dyed with a sublimable dye, such as when the portion consists of a polyester fiber dyed with a disperse dye; when the subject portion consists of a fiber (e.g., cotton, nylon, rayon, hemp, wool, silk, and the like) that has been dyed with a non-sublimable dye, a dye-adsorption layer is not always necessary.

The dye-adsorption layer can, for example, be formed as a black layer by printing an ink prepared by blending activated charcoal as an adsorbent in a substantially colorless transparent resin ink with a resin as described above as the principal ingredient, and can also be formed as a gray layer by printing such an ink blended with a white pigment such as titanium oxide along with activated charcoal.

The thickness of the dye-adsorption layer can be, for example, approximately 10 to 50 micro m; however, this is not to be construed as limiting.

The dye-adsorption layer can be formed on the side opposite to the hologram-forming layer of the design-forming layer and, when an adhesive layer is present, between the design-forming layer and the adhesive layer. When the dye-adsorption layer is a black layer, it is preferable that a masking layer be present between the design-forming layer and the dye-adsorption layer to prevent the appearance, view, or the like of the design by the design-forming layer from being influenced by the dye-adsorption layer.

(5) As stated above, the design-forming layer (including the design-forming layer provided with a protective layer) can be formed to have an external form (or outline) corresponding to the external form (or outline) of the design to be formed on the subject, and the adhesive layer, the masking layer, the dye-adsorption layer, or the like that have an external form or outline corresponding substantially to said external form or outline can be stacked on the design-forming layer; however, this is not to be construed as limiting.

The design-forming layer (including a design-forming layer with a protective layer) can also be formed over a wider range than the external form (or outline) of the design to be formed on the subject (e.g., on all or a portion of the base material or the hologram-forming layer), an adhesive layer, a masking layer, a dye-adsorption layer, or the like can also be stacked on the design-forming layer over a wider range than the external form (or outline) of the design to be formed on the subject, and the resulting transfer sheet for hologram and design formation can be used as a cutting sheet or the like with the various layers, except the base material and the hologram-forming layer (or the base material only), removed from the portions other than the desired design.

In this case, the design-forming layer, the masking layer, the dye-adsorption layer, or the like can be formed by, for example, knife coater coating or screen printing, and an adhesive layer can be formed by, for example, screen printing, coating, or thermal melting extrusion film casting using the T-die method; however, for all these layers, this is not to be construed as limiting.

2. Subject

Subjects to have a design formed thereon using the transfer sheet for hologram and design formation of the present invention include, for example, colored or non-colored clothlike fiber products such as woven fabrics, knittings, and nonwovens, textile products made of such a clothlike fiber product (e.g., clothes such as sport wears, T-shirts, and polo shirts, hats/caps, mufflers, socks, and the like), and leathers or leather-based products (e.g., clothes, belts, footwear, hats/caps, and the like); however, other flexible articles or non-flexible articles can also serve as subjects.

3. Method of Design Formation

A design can be formed using the transfer sheet for hologram and design formation of the present invention as described below.

First, the transfer sheet for hologram and design formation is fixed to the subject by means of an adhesive layer or another means on the side opposite to the hologram-forming layer of the design-forming layer (i.e., the side opposite to the base material side of the transfer sheet for hologram and design formation).

When the transfer sheet for hologram and design formation used to form a design is one having a hologram-forming layer formed on all or a portion of a specified face of a heat-resistant sheet-like base material, and having an adhesive layer that can be fusion bonded to the subject by heating and pressurization and fixed to the subject by cooling on the side opposite to the base material (on the side opposite to the hologram-forming layer of the design-forming layer via another layer as required), the transfer sheet for hologram and design formation is fixed to the subject as follows: the transfer sheet for hologram and design formation is heated and pressed against the subject using, for example, a hot press machine or an iron at a temperature at which the adhesive layer melts, whereas no other layer undergoes melting, damage, and the like, from the side opposite to the hologram-forming layer of the sheet-like base material, while the adhesive layer is in contact with the subject, to fusion bond the adhesive layer to the subject. Thereafter, the adhesive layer is solidified by spontaneous cooling or another means of cooling to fix the transfer sheet for hologram and design formation to the subject.

Thus, while the transfer sheet for hologram and design formation is fixed to the subject on the side opposite to the base material, the base material and the hologram-forming layer are separated from the design-forming layer to peel the hologram-forming layer from the design-forming layer.

Thereby, the design-forming layer from which the hologram-forming layer has departed is fixed to the subject, and a design having a hologram-recording area by fine embossment appears on a surface portion of the design-forming layer which surface portion has been formed upon the peeling.

### EXAMPLES

The present invention is hereinafter described in further detail with reference to Examples, to which, however, the present invention is not limited. Note that “parts” as mentioned in Examples and elsewhere means “parts by weight” unless otherwise stated.

### Example 1

Thermal Transfer Sheet 1

An ultraviolet curing resin ink was coated uniformly over the entire surface of one face of a base sheet [sheet-like base material (the same applies below)] (100 micro m thick polyester film) to provide an ink film.

By pressing an embossing die against the entire surface of the ink film, a reversed embossment in a reversed form of a desired hologram record by fine embossment (one capable of reproducing a star-shaped interference pattern) was provided.

By applying an ultraviolet ray to the ink film in this state to cure the ink film and make the reversed embossment a cured reversal-embossment-recording area, a hologram-forming layer was provided on the one face of the base sheet.

Using a 180-mesh screen plate on which a circular design having a diameter of 4 cm was formed, the circular design was printed and dried with a red ink at a specified position on the reversal-embossment-recording area of the hologram-forming layer to provide a design-forming layer peelable from the hologram-forming layer.

The red ink used consisted of 100 parts of HG Type Clear Ink (trade name for a clear ink including a urethane resin, a solvent, a silicone-based defoaming agent, and silicon oxide: manufactured by Matsui Shikiso Chemical Co., Ltd.) and 10 parts of HG Type Color Base Red BR (trade name for a toner pigment including a red pigment, a solvent, a urethane resin, and a dispersing agent: manufactured by Matsui Shikiso Chemical Co., Ltd.).

Using a 150-mesh screen plate on which a shape whose outer peripheral margin was shrunken by 0.2 mm from the aforementioned design of a circle having a diameter of 4 cm (a circle having a diameter of 3.96 cm) was formed, the circular shape was printed and dried with a white hiding ink concentrically with the circular design on the design-forming layer to provide a masking layer.

The white hiding ink used was HG Type White Ink (trade name for a white ink including titanium oxide, a urethane resin, a solvent, and a silicone-based defoaming agent: manufactured by Matsui Shikiso Chemical Co., Ltd.).

Furthermore, using a 100-mesh screen plate on which a shape whose outer peripheral margin was extended by 0.5 mm from the aforementioned design of a circle having a diameter of 4 cm (a circle having a diameter of 4.1 cm) was formed, the circular shape was printed and dried with an adhesive layer ink prepared by dispersing hot melting resin particles in a resin ink to have a dried thickness of 100 micro m concentrically with the circular design on the masking layer, to provide an adhesive layer.

The adhesive layer ink used was HG Type Adhesive Ink (trade name for an adhesive layer ink including a urethane resin, hot melt nylon resin particles, and a silicone-based defoaming agent: manufactured by Matsui Shikiso Chemical Co., Ltd.).

Thus, a thermal transfer sheet [a transfer sheet for hologram and design formation in the form of a flexible sheet (the same applies below)] 1 composed of a hologram-forming layer, a design-forming layer, a masking layer, and an adhesive layer that are stacked in this order on a base sheet was obtained.

Thermal Transfer

The thus-obtained thermal transfer sheet 1 was heated and pressurized using a hot press machine under the conditions of 180 degrees Celsius and 35 kPa for 10 seconds, while the adhesive layer was in contact with a specified portion of a black cotton knitting, to fusion bond the adhesive layer to the black cotton knitting, and then solidifying the adhesive layer by spontaneous cooling to fix the adhesive layer to the black cotton knitting.

Thereafter, the hologram-forming layer, integrally with the base sheet, was peeled from the design-forming layer to fix the design-forming layer from which the hologram-forming layer had separated and the masking layer to the black cotton knitting by the adhesive layer, resulting in the formation of a design having a hologram-recording area by fine embossment on a surface portion of the design-forming layer which surface portion had been formed upon the peeling, i.e., a brilliantly red circular shape having a diameter of 4 cm that produces a star-shaped holographic interference pattern on the black cotton knitting, depending on the viewing angle, appears.

Fastness

When the black cotton knitting with the design-forming layer and the like (hologram-design-bearing object) was subjected to 10 repeats of a washing test according to the JIS L-0217 103 method (5-grade method), a good washing fastness of grade 4 was obtained; even after the repeated washing test, no change was observed in the design and the star-shaped holographic interference pattern by the design-forming layer.

### Example 2

Thermal Transfer Sheet 2

In the same manner as Example 1, a hologram-forming layer was provided on one face of a base sheet (100 micro m thick polyester film). Using a 180-mesh screen plate on which a circular design having a diameter of 4 cm was formed, the circular design was double printed and dried with the white ink used in Example 1 at a specified position on the reversal-embossment-recording area of the hologram-forming layer to provide a white design-forming layer with hiding function that was peelable from the hologram-forming layer.

Using a 150-mesh screen plate on which a shape whose outer peripheral margin was shrunken by 0.5 mm from the aforementioned design of a circle having a diameter of 4 cm (a circle having a diameter of 3.9 cm) was formed, the circular shape was double printed and dried with a dye adsorption ink concentrically with the circular design on the design-forming layer to provide a dye-adsorption layer.

The dye-adsorption layer ink used was HG Type activated charcoal ink (trade name for a dye adsorption ink including activated charcoal, a urethane resin, a solvent, and a silicone-based defoaming agent: manufactured by Matsui Shikiso Chemical Co., Ltd.). Furthermore, using a 100-mesh screen plate on which a shape whose outer peripheral margin was extended by 0.2 mm from the aforementioned design of a circle having a diameter of 4 cm (a circle having a diameter of 4.04 cm) was formed, the circular shape was printed and dried with an adhesive layer ink to have a dried thickness of 80 micro m concentrically with the circular design on the dye-adsorption layer. Subsequently, by uniformly spreading the hot melt nylon resin particles used in the adhesive layer ink in Example 1 over the adhesive layer ink remaining undried, and removing excessive particles with a brush, and then performing a heat treatment at 130 degrees Celsius for 3 minutes, an adhesive layer wherein the resin ink and the hot melting resin particles were in a unified form was obtained.

The adhesive layer ink used consisted of Matsumin AR Binder GS (trade name for a clear binder including an aqueous urethane resin emulsion: manufactured by Matsui Shikiso Chemical Co., Ltd.).

Thus, a thermal transfer sheet 2 composed of a hologram-forming layer, a design-forming layer, a dye-adsorption layer, and an adhesive layer that were stacked in this order on a base sheet was obtained.

Thermal Transfer

The thus-obtained thermal transfer sheet 2 was heated and pressurized using a hot press machine under the conditions of 180 degrees Celsius and 35 kPa for 10 seconds, while the adhesive layer thereof was in contact with a specified portion of a black polyester knitting (one dyed with a disperse dye), to fusion bond the adhesive layer to the black polyester knitting, and then the adhesive layer was solidified by spontaneous cooling to fix the adhesive layer to the black polyester knitting.

Thereafter, by peeling the hologram-forming layer, integrally with the base sheet, from the design-forming layer to fix the design-forming layer from which the hologram-forming layer had separated and the dye-adsorption layer to the black polyester knitting by the adhesive layer, resulting in the formation of a design having a hologram-recording area by fine embossment on a surface portion of the design-forming layer which surface portion had been formed upon the peeling, i.e., a brilliantly white circular shape having a diameter of 4 cm that produces a star-shaped holographic interference pattern, depending on the viewing angle, appears, on the black polyester knitting. No contamination with the disperse dye of the subject was observed in the design by the design-forming layer.

Fastness

When a black polyester knitting with the design-forming layer and the like (hologram-design-bearing object) was subjected to a washing test in the same manner as Example 1, a good washing fastness of grade 4 was obtained; even after the repeated washing test, no change was observed in the design or the star-shaped holographic interference pattern by the design-forming layer.

### Example 3

Thermal Transfer Sheet 3

In the same manner as Example 1, a hologram-forming layer was provided on one face of a base sheet (100 micro m thick polyester film).

Using a 180-mesh screen plate on which a shape whose outer peripheral margin was extended by 0.2 mm from the design of a circle having a diameter of 4 cm (a circle having a diameter of 4.04 cm) was formed, the circular shape was printed and dried with HG Protective Layer Ink (trade name for a protective layer ink including a urethane resin, silicone, and a solvent: manufactured by Matsui Shikiso Chemical Co., Ltd.) at a specified position on the reversal-embossment-recording area of the hologram-forming layer to provide a protective layer peelable from the hologram-forming layer.

Subsequently, a thermal transfer sheet 3 was obtained by stacking a design-forming layer, a masking layer, and an adhesive layer on the protective layer each concentrically with the circle of the protective layer, in the same manner as Example 1.

Thermal Transfer

The thus-obtained thermal transfer sheet 3 was heated and pressurized using a hot press machine under the conditions of 180 degrees Celsius and 50 kPa for 10 seconds, while the adhesive layer was in contact with a specified portion of the black nylon knitting to fusion bond the adhesive layer to the black nylon knitting, and then the adhesive layer was solidified by spontaneous cooling to fix the adhesive layer to the black nylon knitting.

Thereafter, by peeling the hologram-forming layer, integrally with the base sheet, from the design-forming layer, the protective layer from which the hologram-forming layer had separated, design-forming layer, and masking layer was fixed to the black nylon knitting by the adhesive layer, and a design by the design-forming layer with the protective layer on the surface side thereof, having a hologram-recording area with a hologram recorded by fine embossment on the surface portion formed upon the peeling, i.e., a brilliantly red circular design having a diameter of 4 cm, and producing a star-shaped holographic interference pattern, depending on the viewing angle, was formed on the black nylon knitting.

Fastness

When the black nylon knitting having the design-forming layer and the like (hologram-design-bearing object) was subjected to a washing test in the same manner as Example 1, a good washing fastness of grade 4-5 was obtained; even after the repeated washing test, no change was observed in the design or the star-shaped holographic interference pattern by the design-forming layer.

### Example 4

Thermal Transfer Sheet 4

In the same manner as Example 1, a hologram-forming layer was provided on one face of a base sheet (100 micro m thick polyester film).

By sequentially printing and drying specified designs with a red ink (trade name “K Display”: manufactured by DIC Graphics Corporation), a blue ink (trade name “VIP”: manufactured by DIC Graphics Corporation), a yellow ink (trade name “K Display”: manufactured by DIC Graphics Corporation), and a black ink (trade name “D”: manufactured by DIC Graphics Corporation), each of the oxidation polymerization type, on the reversal-embossment-recording area of the hologram-forming layer using an offset printing machine, a design-forming layer for a rose design was provided.

Provided on the design-forming layer was a masking layer in a shape whose outer peripheral margin was shrunken by 0.2 mm from the aforementioned design with a white masking layer ink in the same manner as Example 1, and provided on the masking layer was a dye-adsorption layer in a shape whose outer peripheral margin was shrunken by 0.5 mm from the design in the same manner as Example 2.

Furthermore, using a 100-mesh screen plate on which a shape whose outer peripheral margin was extended by 0.5 mm from the aforementioned design was formed, said shape was printed and dried with an adhesive layer ink prepared by dispersing hot melting resin particles in a resin ink to have a dried thickness of 120 micro m on the dye-adsorption layer, to provide an adhesive layer.

The adhesive layer ink used was HG Type Adhesion Layer Ink 2 (trade name for an adhesive layer ink including a urethane resin, hot melt polyester resin particles, and a silicone-based defoaming agent: manufactured by Matsui Shikiso Chemical Co., Ltd.).

Thus, a thermal transfer sheet 4 composed of a hologram-forming layer, a design-forming layer, a masking layer, a dye-adsorption layer, and an adhesive layer that are stacked in this order on a base sheet was obtained.

Thermal Transfer

The thus-obtained thermal transfer sheet 4 was heated and pressurized using a hot press machine under the conditions of 160 degrees Celsius and 50 kPa for 10 seconds, while the adhesive layer thereof was in contact with a specified portion of a black polyester knitting (one dyed with a disperse dye), to fusion bond the adhesive layer to the black polyester knitting, and then the adhesive layer was solidified by spontaneous cooling to fix the adhesive layer to the black polyester knitting.

Thereafter, by peeling the hologram-forming layer, integrally with the base sheet, from the design-forming layer to fix the design-forming layer from which the hologram-forming layer had separated, masking layer, and dye-adsorption layer to the black polyester knitting by the adhesive layer, and a design having a hologram-recording area by fine embossment on the surface portion of the design-forming layer which surface portion had been formed upon the peeling, i.e., a brilliant rose design that produces a star-shaped holographic interference pattern appears, depending on the viewing angle, was formed on the black polyester knitting. In the design by the design-forming layer, no contamination with the disperse dye of the subject was observed.

Fastness

When the black polyester knitting having the design-forming layer and the like (hologram-design-bearing object) was subjected to a washing test in the same manner as Example 1, a good washing fastness of grade 4 was obtained; even after the repeated washing test, no change was observed in the design or the star-shaped holographic interference pattern by the design-forming layer.

### Example 5

Thermal Transfer Sheet 5

A hologram-forming layer was provided on one face of a rolled base sheet [sheet-like base material] (100 micro m thick polyester film) in the same manner as Example 1.

By coating and drying the red ink used in Example 1 over the entire surface on the reversal-embossment-recording area of the hologram-forming layer using a knife coater, a design-forming layer peelable from the hologram-forming layer was provided.

By coating and drying the white hiding ink used in Example 1 over the entire surface on the design-forming layer using a knife coater, a masking layer was provided.

Furthermore, by coating hot melt nylon resin particles in a thermally molten state over the entire surface on the masking layer by extrusion molding using the T-die method, and solidifying it by cooling, an adhesive layer was formed.

Thus, a thermal transfer sheet 5 composed of a hologram-forming layer, a design-forming layer, a masking layer, and an adhesive layer that are stacked in this order on the rolled base sheet was obtained.

Thermal Transfer

The thus-obtained thermal transfer sheet 5 from which the design-forming layer, the masking layer, and the adhesive layer had been removed in the portions other than the circle having a diameter of 4 cm, which was the desired figure, using a cutting machine (i.e., one having only the base sheet and the hologram-forming layer remaining in the portions other than the desired figure) was heated and pressurized using a hot press machine under the conditions of 180 degrees Celsius and 50 kPa for 10 seconds, while the adhesive layer of the desired figure was in contact with a specified portion of a black nylon knitting, to fusion bond the adhesive layer to the black nylon knitting, and then the adhesive layer was solidified by spontaneous cooling to fix the adhesive layer to the black nylon knitting.

Thereafter, by integrally peeling the base sheet and the hologram-forming layer from the design-forming layer to fix the design-forming layer from which the hologram-forming layer had separated and masking layer to the black nylon knitting by the adhesive layer, and a design having a hologram-recording area by fine embossment on the surface portion of the design-forming layer which surface portion had been formed upon the peeling, i.e., a brilliantly red circular design having a diameter of 4 cm that produces a star-shaped holographic interference pattern, depending on the viewing angle, was formed on the black nylon knitting.

Fastness

When the black nylon knitting having the design-forming layer and the like (hologram-design-bearing object) was subjected to a washing test in the same manner as Example 1, a good washing fastness of grade 4 was obtained; even after the repeated washing test, no change was observed in the design or the star-shaped holographic interference pattern by the design-forming layer.

### Comparative Example 1

Thermal Transfer Sheet NG1

By uniformly coating and drying a peeling layer ink over the entire surface of one face of a base sheet (100 micro m thick polyester film), a peeling layer was provided. The peeling layer ink used was WAX INK (trade name for a peelable ink including a wax, silicone, and a solvent: manufactured by Matsui Shikiso Chemical Co., Ltd.).

By providing a hologram-forming layer on the peeling layer in the same manner as Example 1, and sequentially stacking a design-forming layer, a masking layer, and an adhesive layer on the reversal-embossment-recording area of the hologram-forming layer, in the same manner as Example 1, a thermal transfer sheet NG1 was obtained.

Thermal Transfer

By fixing the adhesive layer of the thus-obtained thermal transfer sheet NG1 to a black cotton knitting in the same manner as Example 1, and then peeling the base sheet from the hologram-forming layer, the hologram-forming layer, the design-forming layer, and the masking layer were fixed to the black cotton knitting by the adhesive layer, and a design by the design-forming layer, i.e., a red circular design having a diameter of 4 cm, was formed on the black cotton knitting; however, no star-shaped holographic interference pattern appeared brilliantly on the design; the desired hologram-design-bearing object was not obtained.

### Comparative Example 2

Thermal Transfer Sheet NG2

By uniformly coating and drying the peeling layer ink used in Comparative Example 1 over the entire surface of one face of a base sheet (100 micro m thick polyester film), a peeling layer was provided, on which a hologram-forming layer was provided in the same manner as Example 1.

By forming a metal thin film layer (aluminum vapor-deposited layer) on the reversal-embossment-recording area of the hologram-forming layer, and sequentially stacking a design-forming layer, a masking layer, and an adhesive layer on the metal thin film layer in the same manner as Example 1, a thermal transfer sheet NG2 was obtained.

Thermal Transfer

By fixing the adhesive layer of the thus-obtained thermal transfer sheet NG2 to a black cotton knitting in the same manner as Example 1, and then peeling the base sheet from the hologram-forming layer, the hologram-forming layer, the metal thin film layer, the design-forming layer, and the masking layer were fixed to the black cotton knitting by the adhesive layer. The thus-obtained design was a circular design having a diameter of 4 cm, and producing a not red but whitish silver star-shaped interference pattern; the desired hologram-design-bearing object was not obtained.

### Comparative Example 3

Thermal Transfer Sheet NG3

In the same manner as Example 1, a hologram-forming layer was provided on one face of a base sheet (100 micro m thick polyester film).

By uniformly coating and drying the wax ink used in Comparative Example 1 on the hologram-forming layer, a mold-release layer was provided.

By sequentially stacking a design-forming layer, a masking layer, and an adhesive layer on the mold-release layer in the same manner as Example 1, a thermal transfer sheet NG3 was obtained.

Thermal Transfer

By performing a treatment in the same manner as Example 3 except that the thermal transfer sheet NG3 was used in place of the thermal transfer sheet 3, a mold-release layer from which the hologram-forming layer had separated, design-forming layer, and masking layer from which the hologram-forming layer had departed was fixed to a black nylon knitting by the adhesive layer, and a design by the design-forming layer with a mold-release layer on the top surface side, having a hologram-recording area with a hologram recorded by fine embossment on the surface portion formed upon the peeling, i.e., a brilliantly red circular design having a diameter of 4 cm, and producing a star-shaped holographic interference pattern, depending on the viewing angle, was formed on the black nylon knitting; however, no brilliant interference pattern appeared in a portion of the design.

Fastness

When the black nylon knitting with the design-forming layer and the like (hologram-design-bearing object) was subjected to a washing test in the same manner as Example 1, no star-shaped holographic interference pattern appeared on the design by the design-forming layer after the repeated washing test; no hologram-design-bearing object with sufficient fastness was obtained.

What is claimed is:

1. A transfer sheet for hologram and design formation comprising a sheet-like base material, a hologram-forming layer, and a design-forming layer,
said hologram-forming layer is formed on all or a portion of a specified face of said base material,
said hologram-forming layer has a reversal-embossment-recording area with a desired hologram record by fine embossment in a reversed state on all or a portion of the side opposite to the base material,
a portion including at least a portion of the reversal-embossment-recording area or all of said side where said hologram-forming layer has said reversal-embossment-recording area and said design-forming layer are stacked, peelability exists between the hologram-forming layer and the design-forming layer, and
a design having a hologram-recording area by fine embossment appears on a surface portion of the design-forming layer which surface portion has been formed upon the peeling of the hologram-forming layer and the design-forming layer from each other.

2. The transfer sheet for hologram and design formation according to claim 1, having a masking layer on the side opposite to the hologram-forming layer of the design-forming layer.

3. The transfer sheet for hologram and design formation according to claim 1, having an adhesive layer on the side opposite to the hologram-forming layer of the design-forming layer.

4. The transfer sheet for hologram and design formation according to claim 3, having a masking layer between the design-forming layer and the adhesive layer.

5. The transfer sheet for hologram and design formation according to claim 3, wherein said base material is in the form of a heat-resistant sheet, said adhesive layer, in contact with the subject, is heated and pressurized from the side opposite to the hologram-forming layer of the sheet-like base material to allow the adhesive layer to be fusion bonded to said subject, and to be fixed to the subject upon cooling.

6. The transfer sheet for hologram and design formation according to claim 4, wherein said base material is in the form of a heat-resistant sheet, said adhesive layer, in contact with the subject, is heated and pressurized from the side opposite to the hologram-forming layer of the sheet-like base material to allow the adhesive layer to be fusion bonded to said subject, and to be fixed to the subject upon cooling.

7. The transfer sheet for hologram and design formation according to claim 1, wherein the base material and the hologram-forming layer can be integrally peeled from the design-forming layer.

8. The transfer sheet for hologram and design formation according to claim 4, wherein the base material and the hologram-forming layer can be integrally peeled from the design-forming layer.

9. The transfer sheet for hologram and design formation according to claim 6, wherein the base material and the hologram-forming layer can be integrally peeled from the design-forming layer.

10. The transfer sheet for hologram and design formation according to claim 1, wherein said transfer sheet as a whole is in the form of a flexible sheet.

11. The transfer sheet for hologram and design formation according to claim 6, wherein said transfer sheet as a whole is in the form of a flexible sheet.

12. The transfer sheet for hologram and design formation according to claim 7, wherein said transfer sheet as a whole is in the form of a flexible sheet.

13. A manufacturing process for a transfer sheet for hologram and design formation comprising
a step for forming a hologram-forming layer on all or a portion of a specified face of a sheet-like base material, said hologram-forming layer having a reversal-embossment-recording area with a desired hologram record by fine embossment in a reversed state in all or a portion of the side opposite to the base material, and
a step for stacking a design-forming layer on a portion including at least a portion of said reversal-embossment-recording area or all of said side where said hologram-forming layer has said reversal-embossment-recording area, wherein
peelability exists between the hologram-forming layer and the design-forming layer, and
a design having a hologram-recording area by fine embossment appears on a surface portion of the design-forming layer which surface portion has been formed upon the peeling of the hologram-forming layer and the design-forming layer from each other.

14. The manufacturing process for a transfer sheet for hologram and design formation according to claim 13, having a step for providing an adhesive layer on the side opposite to the hologram-forming layer of the design-forming layer.

15. The manufacturing process for a transfer sheet for hologram and design formation according to claim 14, wherein the base material is in the form of a heat-resistant sheet,
the adhesive layer, in contact with the subject, is heated and pressurized from the side opposite to the hologram-forming layer of the sheet-like base material to allow the adhesive layer to be fusion bonded to the subject, and to be fixed to the subject by cooling.

16. The manufacturing process for a transfer sheet for hologram and design formation according to claim 13, wherein the base material and the hologram-forming layer can be integrally peeled from the design-forming layer.

17. The manufacturing process for a transfer sheet for hologram and design formation according to claim 14, wherein the base material and the hologram-forming layer can be integrally peeled from the design-forming layer.

18. The manufacturing process for a transfer sheet for hologram and design formation according to claim 15, wherein the base material and the hologram-forming layer can be integrally peeled from the design-forming layer.

19. A manufacturing process for a hologram-design-bearing object with a transfer sheet for hologram and design formation,
said transfer sheet comprising a sheet-like base material, a hologram-forming layer, and a design-forming layer,
said hologram-forming layer is formed on all or a portion of a specified face of said base material,
said hologram-forming layer has a reversal-embossment-recording area with a desired hologram record by fine embossment in a reversed state on all or a portion of the side opposite to the base material,
a portion including at least a portion of the reversal-embossment-recording area or all of said side where said hologram-forming layer has said reversal-embossment-recording area and said design-forming layer are stacked, peelability exists between the hologram-forming layer and the design-forming layer, and
a design having a hologram-recording area by fine embossment appears on a surface portion of the design-forming layer which surface portion has been formed upon the peeling of the hologram-forming layer and the design-forming layer from each other,
comprising
a step for fixing the transfer sheet for hologram and design formation to an article on the side opposite to the base material, and
a step for separating the base material and the hologram-forming layer from the design-forming layer to peel the hologram-forming layer from the design-forming layer, thus yielding an object with the design-forming layer from which the hologram-forming layer has separated,
wherein a design having a hologram-recording area by fine embossment appears, upon the peeling, on a surface portion of the design-forming layer which surface portion has been formed upon the peeling.

20. The manufacturing process for a hologram-design-bearing object according to claim 19,
wherein said transfer sheet has an adhesive layer on the side opposite to the hologram-forming layer of the design-forming layer,
said base material is in the form of a heat-resistant sheet, said adhesive layer, in contact with the subject, is heated and pressurized from the side opposite to the hologram-forming layer of the sheet-like base material to allow the adhesive layer to be fusion bonded to said subject, and to be fixed to the subject upon cooling,
in the step for fixing the transfer sheet for hologram and design formation to an article on the side opposite to the base material,
heating and pressurizing the transfer sheet for hologram and design formation from the side opposite to the hologram-forming layer of the sheet-like base material, while the adhesive layer thereof is in contact with the article, to fusion bond the adhesive layer to the article, and
solidifying the fusion bonded adhesive layer by cooling to fix the fusion bonded adhesive layer to the article.
